(19) United States
(12) Patent Application Publication
(10) Pub. No.: US 2007/0164259 A1
(43) Pub. Date: Jul. 19, 2007

(54) Additive system for lubricating fluids

(76) Inventors: William T. Sullivan, Brick, NJ (US); Halou Oumar-Mahamat, Princeton, NJ (US); Shi-Ming Wu, Dayton, NJ (US); Ellen B. Brandes, Round Brook, NJ (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/333,581

(22) Filed: Jan. 17, 2006

(51) Int. Cl. C09K 15/00

(52) U.S. Cl. 252/397

(57) ABSTRACT

The invention concerns an additive package for a lubricating fluid or grease containing an effective amount of a phosphorus-containing antiwear additive, the improvement comprising the absence of primary, secondary, tertiary, cyclic low molecular weight aliphatic amines with a carbon number of C30 or less.

### FIELD OF THE INVENTION

The invention relates to an additive system having essentially no hydrocarbyl amine rust inhibitor of C30 or less, suitable for use in lubricating fluids, and a fully formulated lubricating fluid containing said additive system.

### BACKGROUND OF THE INVENTION

Oxidative stability, seal compatibility, protection from wear, and overall durability are highly sought after features of gears oils for both automotive and industrial applications. Original equipment manufacturers (OEMs) as well as the consuming public are constantly demanding improvements such as extended drain intervals from suppliers of gear oils.

Enhanced oxidative stability is highly desired in driveline fluids (e.g., automotive transmissions and differentials) as well as in gear boxes used for various industrial applications. When oxidation is problematic, sludge and carbon/varnish deposits appear on the gear surfaces, which may adversely impact the functioning of the gears. Lubricants are expected to be able to pass lengthy oxidation tests, e.g. the extended L-60-1 test (comprising a 200 hr test for axle oils and 300 hr test for transmission oils). The lubricant should be able to provide adequate cleanliness as well as viscosity control to pass these tests.

In order to prepare lubricants which are oxidatively stable, it has become common practice to add antioxidants to the lubricating oil, either phenolic or arylamine types. Alternatively, formulators can choose to use certain base stocks and/or additive combinations which are less prone to oxidation.

Gear oils that are expected to survive for long drain intervals should also be able to leave seals undamaged so that no leakage occurs during the lifetime of the gear box. Axle and transmission seal materials in the U.S. and Europe include fluoroelastomer, nitrile and polyacrylate. Static and dynamic seal testing in the U.S. and Europe are part of industry and OEM performance specifications for both industrial and automotive gear oil.

One of the most important features of a gear oil is its ability to prevent gear distress, which if severe enough, can ultimately lead to catastrophic failure of the gears. Gear distress or wear can be in the form of pitting, spalling, ridging, rippling, etc. for automotive gears, especially those in the differential because of the loads. To control wear, it is common to add anti-wear additives to reduce or prevent damage. These additives preferably should be able to function at temperatures from sub-zero to temperatures around 160° C., which could be reached if the vehicle is subjected to severe operating conditions. In addition, to perform most effectively, anti-wear additives preferably should be able to function in the presence of other aggressive additives that perform key functions, e.g. extreme pressure additives, and they preferably should be able to continue to function for long operating periods.

There are industry tests for examining the effectiveness of antiwear additive systems. In the automotive industry, the L-37 is most widely recognized. This rig test simulates low speed, high torque operation. A low temperature modification of this test is also part of the API GL-5 and SAE J2360 specification for 75 W graded gear lubricants. The low temperature version of this test is known as the Canadian version. There also exists a high temperature version of the L-37 test, which is included in several OEM specifications. In the L-37 test, and its variants, the gears are disassembled at the end of the test and the gear distress is rated.

Commonly used anti-wear additives are phosphorous containing compounds. They usually include amine-neutralized salts of phosphorus acids, phosphinyl acids, phosphonyl acids, thiophosphorus acids, thiophosphinyl acids, thiophosphonyl acids, and the partial esters of these. The amines useful in preparing the amine salts are primary or secondary hydrocarbyl monoamines or polyamines containing about 4-30 carbon atoms. They may also be tertiary or cyclic amines. The most common amines are primary, fatty amines containing 10-20 carbon atoms, like octadecyl amine or tertiary alkyl amines like C12-C14 tertiary alkyl primary amine, commercially available as “Primene 81-R.” It is commonly believed that the amine neutralization is a necessary feature of the different phosphorus-containing compounds, because of its ability to impart critically required steel corrosion protection and thermal stability.

In order to reach the extended drain intervals that OEMs are now seeking for their gear boxes and differentials, durability is important for gear oils, both automotive and industrial. The durability of a fluid will depend on the base oils that are being used, e.g. synthetic base oils will be far more durable than API Group I and II fluids because of the superior oxidative and thermal stability. However, base oil selection is only part of the picture for formulating gear oils with improved durability. The additive system must also be carefully chosen so as to provide oxidation stability, seal compatibility and antiwear performance, all of which contribute to an oil's durability.

Industrial and automotive gear lubes perform in much the same way, though loads on the industrial gears tend to be spread out over larger surface areas and therefore are not as great as those seen in the rear axle of an automotive vehicle. Nevertheless, similar features would be considered desirable in both types of gear oils. Durability, for example, is important as this would equate to longer drain intervals and reduced down time and reduced maintenance costs. Durability in the form of improved oxidative stability, reduced wear and better seal compatibility are highly desired for all types of gear oils.

Because there are numerous additives added to such compositions for many diverse reasons and with each additive interacting with all the other additives in some manner, it is extremely difficult to find new formulations showing an improvement in at least one property while having little or no detrimental effects on other properties. Nevertheless, the prior art is filled with many attempts to prepare gear additive concentrates and gear lubricant compositions with improvements in the areas of extreme pressure/antiwear, thermal stability, oxidative stability and the like.

U.S. Pat. No. 6,844,300 and EP 1 233 051 A1 teach that a gear oil comprising a base oil, a thermally stable P-containing antiwear additive and a metal free sulfur EP agent, wherein the S is present at least at a level of 10,000 ppms, and the P is present from 100-350 ppms will meet GL-5 requirements. The thermally stable antiwear additive is defined as oil soluble amine salts of phosphoric acid esters as well as reaction products of dicyclopentadiene and thiophosphoric acid. The salts may be formed beforehand or in situ.

U.S. Pat. No. 6,046,144 describes synergistic antioxidant compositions comprising amine salts of alkyl phosphates, and ethylenediamine, ammonium or metal salts of alkylarylsulfonates.

U.S. Pat. No. 5,942,470 teaches the use of combining at least one oil soluble sulfur-containing extreme pressure or antiwear agent with at least one oil soluble amine salt of a partial ester of an acid of phosphorus and with at least one oil soluble succinimide dispersant of a formula defined in the patent. A lengthy list of many suitable amine salts of the partially esterified phosphorus is included in the patent. Primary amines are preferred.

U.S. Pat. No. 5,763,372 discusses “clean gear” boron-free gear additive systems, which employ an ashless boron-free dispersant, a sulfur source, and a phosphorus source, wherein at least one is chosen from a group of oil-soluble amine salts of acid phosphates.

U.S. Pat. No. 5,756,429 describes a composition suitable for high speed gears having a peripheral speed of at least 10 m/sec containing a base oil having a % Ca of 5 or less and a S, P, N ratio of 100N/(S+P) between 4 and 10 by weight. Use of acid phosphates and their amine salts are preferred. The composition is said to be able to inhibit sludge and permit the prolongation of the life of an oil seal.

U.S. Pat. No. 5,691,283 describes a transmission and axle or differential gearing which comprises a base oil and a Mannich dispersant, a sulfur-containing EP agent, a P- and N-containing antiwear additive, and an overbased alkali or alkaline earth carboxylate, sulphonate, or sulfurized phenate having a TBN (Total Base Number) of at least 145.

U.S. Pat. No. 5,573,696 and U.S. Pat. No. 5,500,140 discuss the preparation of amine-neutralized acid phosphates, which are prepared by reacting P₂O₅ with an alcohol prepared from the reaction of an epoxide with dihydrocarbyl phosphorothioic acid.

U.S. Pat. No. 5,547,596 describes a lubricant composition for the limited slip differential (LSD) of a car which is obtained by adding a phosphate amine salt, such as an amine salt of an oleyl acid phosphate and a borated ashless dispersant, such that the ratio of N/P is 0.5-1.0; the ratio of N/B is 4-10; the phosphorus content is in the range of 0.15-0.4% by weight; and the boron content is in the range of 0.01 to 0.04% by weight. This lubricant composition inhibits the generation of chattering during the operation of a LSD device and has excellent oxidative stability.

U.S. Pat. No. 5,358,650, U.S. Pat. No. 5,571,445, and WO 94/22990 describe a synthetic fluid which includes a variety of synthetic base oils plus specified amounts of the following: a sulfur-containing extreme pressure-antiwear agent, a P-containing antiwear agent, a corrosion inhibitor, an amine and/or carboxylic acid rust inhibitor, a foam inhibitor, and an ashless dispersant.

U.S. Pat. No. 5,354,484 describes how improved high temperature stability can be achieved with the presence of at least one soluble tertiary aliphatic primary amine salt, wherein the primary amine contains 4-30 carbon atoms, at least one of which is a substituted phosphoric acid, in combination with a borated succinimide dispersant.

U.S. Pat. No. 5,328,619 describes an additive concentrate comprising at least one oil soluble organic acid, e.g. one or more hydrocarbyl phosphoric acids, one or more carboxylic acids or a combination of the two, and a hydrocarbyl amine which is added such that the pH of the finished concentrate is in the 6.0-7.0 range. A borated dispersant is introduced into the concentrate being formed when the concentrate is at least 6.0. The resulting compositions are said to inhibit haze in the resulting concentrates, and the pH control can provide gear compositions having enhanced extreme pressure performance in the L-42 test, and improved rust in the L-33 test.

U.S. Pat. No. 4,575,431 discusses the combination of dihydrocarbyl hydrogen thiophosphates and hydrocarbyl dihydrogen phosphates and dihydrocarbyl hydrogen phosphates, with the phosphates being at least 50% neutralized with a hydrocarbyl amine that is C10-C30.

U.S. Pat. No. 4,431,552 discusses a lubricating composition having dispersed therein a hydrated alkali metal borate extreme pressure agent and an effective amount of a mixture of a phosphate, a monothiophosphate, and a dithiophosphate. All of the phosphates are preferably used as their hydrocarbyl amine salts.

U.S. Pat. No. 4,118,328 discusses the preparation and use of phosphate salts comprised of heating a triaryl phosphate and a primary or secondary aliphatic amine in a 1-20 molar ratio, respectively, with a trace amount of boric acid for catalyst.

U.S. Pat. No. 3,728,260 describes the preparation of a neutral hydrocarbyl phosphate in combination with an alkyl amine hydrocarbyl phosphate salt for improved load carrying.

EP 531 585 describes the use of an additive composition which includes a borated Mannich dispersant, a sulfur containing anti-wear or EP agent, a metal free phosphorus-containing antiwear-EP agent, and an oil-soluble amine salt of a carboxylic acid. Free amine may or may not be present, and may or may not be complexed to the phosphorus antiwear agent.

EP 519 760 B1 teaches that an oil soluble amine is used to adjust the pH of an additive concentrate to 6-7 then dispersant is added after this adjustment is made.

EP 391 653 BI and EP 450 208 B1 both discuss having high concentrations of amines along with suitable quantities of weak acids, e.g. carboxylic acids, in the presence of sulfurized isobutylene and P-containing antiwear additives to provide gear oils with improved gear performance based on the results of a Planetary Spur Gear Test.

UK 2,108,147 examines the use of oil soluble overbased sodium salts of phosphate esters in lubricant compositions.

WO 03/1004620 A2 discusses a lubricating composition with improved efficiency for an emissions control system, wherein the compositions contain a metal-containing detergent, a metal salt of one or more phosphorus acids or the corresponding esters, and an acylated nitrogen-containing compound having at least 10 carbon atoms. The resulting TBN composition has a phosphorus concentration of up to about 0.12%.

U.S. Pat. No. 4,900,460 covers sulfurized olefins reacted with phosphates and phosphites. The reaction product is useful as an extreme pressure and wear additive for lube compositions.

U.S. Pat. No. 3,513,093 describes a composition containing a major part of a lubricating oil and minor portion of a substituted polyamine, which is prepared by reacting a polyamine with a succinic acid producing hydrocarbon having at least 50 carbons with at least 0.001 moles of a phosphorus acid producing compound selected from the class of phosphoric acids, phosphorus acids, phosphonyl acids, phosphinyl acids, etc. These species were found to give improved oxidation performance in a variety of bench and engine tests.

U.S. Pat. No. 2,224,695 teaches the preparation of a corrosion inhibitor for metals which comprises an ester of an acid of phosphorus having at least one of the hydrogen atoms of the acid replaced by an ester group and at least one of the hydrogen atoms replaced by an inorganic radical, upon exposing it to a metal surface. Under favorable conditions, it reacts chemically with metal surfaces to form a protective coating and inhibit corrosive wear.

EP 531 000 B1 discusses an additive composition containing a.) a reaction product of a phosphorus or thiophosphorus acid with an ashless dispersant and a boron compound and b.) a sulfur containing antiwear-EP agent. The gear oil prepared with these components is said to have these performance improvements: 1.) inhibition of scoring/scuffing, 2.) improved wear in the form of ridging, rippling, pitting and spalling, 3.) improved oxidation in the form of reduced sludge and varnish deposits, especially at higher temperatures.

The present inventors have surprisingly discovered an additive package, suitable for preparing a lubricant or grease composition, that does not make use of primary, secondary, tertiary, or cyclic aliphatic low molecular weight (<C30) amines and therefore, it does not contain the corresponding acid phosphate amine salts, and yet, it provides for lubricants exhibiting, in preferred embodiments, improved performance in at least one of the areas of oxidative stability, seal compatibility, and anti-wear protection, while causing no significant deficits in other important areas of performance.

### SUMMARY OF THE INVENTION

The invention is directed to an additive package for lubricating fluids or greases, the improvement characterized by the absence of primary, secondary, tertiary and cyclic hydrocarbyl amines with a carbon number of C30 or less and the absence of the corresponding acid phosphate amine salts.

In an embodiment, the additive system is further characterized by possessing a total base number (TBN) of less than 22.

In an embodiment, the invention is further characterized as comprising an effective amount of an acid phosphate antiwear additive. In preferred embodiments, the phosphate antiwear additive will be at least one mono- and/or dialkyl acid phosphate effective for antiwear protection.

Preferred mono- and/or dialkyl acid phosphates are represented by the formula (R₁O)(R₂O)P(O)OH, where R₁ is hydrocarbyl and R₂ is hydrocarbyl or hydrogen. R₁ and R₂ may have the same or different hydrocarbyl groups.

It is an object of the invention to provide an additive package suitable for preparing fully formulated lubricating fluids and greases and preferably having improvements in at least one of the properties of antiwear protection, oxidative stability, and seal performance.

These and other objects, features, and advantages will become apparent as reference is made to the following detailed description, preferred embodiments, examples, and appended claims.

### BRIEF DESCRIPTION OF THE DRAWINGS

In the accompanying drawings, like reference numerals are used to denote like parts throughout the several views.

FIG. 1 is a comparison of TBN for formulations according to embodiments of the invention versus a commercial additive package.

FIG. 2 is a comparison of the carbon varnish rating of formulations according to embodiments of the present invention versus formulations outside of the present invention.

### DETAILED DESCRIPTION

According to embodiments of the invention, an additive package is provided without, or essentially free of, the use of primary, secondary, tertiary, and cyclic hydrocarbyl amine rust inhibitors with carbon numbers of C30 or less, and/or the corresponding acid phosphate amine salts which, in certain embodiments, provides improvements in at least one of the areas of oxidation stability, seal compatibility and anti-wear performance, while causing no appreciable deficits in other areas of performance. Such lubricant and grease compositions are particularly useful in automotive gear boxes and differentials as well as industrial gear boxes.

In preferred embodiments, the additive package of the invention comprises an acid phosphate antiwear additive, preferably one or more hydrocarbyl or dihydrocarbyl acid phosphates, said additive package characterized as essentially free of acid phosphate hydrocarbyl amine salts, where the hydrocarbyl amine is C30 or less, present in said fully formulated compositions. Until now, it has been believed that the stability of a phosphate-containing antiwear additive was dependent on the presence of this hydrocarbyl amine such that the phosphorus species is present, wholly or at least in part, as a salt of the amine with the acid phosphate. It is the surprising discovery of the present inventors that such is not the case. Moreover, improvements in certain important properties are evident in certain compositions according to embodiments of the present invention.

It should be understood that in the expression “effective amount of a acid phosphate antiwear additive”, both the “effective amount” and the identity of the acid phosphate-containing compound effective as an antiwear additive can readily be determined by one of ordinary skill in the art in possession of the present disclosure without more than routine experimentation.

As used herein, the term “phosphate” does not include any of the sulfur-containing compounds, e.g., thiophosphate compounds. In an embodiment, the acid phosphate may be present as the mono and/or dihydrocarbyl esters of the acid phosphate. The resulting gear lubricant is essentially free of hydrocarbyl primary, secondary, tertiary, and cyclic hydrocarbyl amines with less than or equal to 30 carbons as an ingredient (when the invention is expressed as a “recipe” of ingredients) and therefore the final fully formulated lubricant is essentially free of the corresponding acid phosphate amine salts.

In order to avoid misunderstanding, “essentially free of” allows minor amounts, such as inevitable impurities which might lead to the presence of one or more of primary, secondary, tertiary, cyclic aliphatic amines with thirty carbons or less (C30 or less) and/or the presence of the corresponding acid phosphate amine salts, but these ingredients and the constituents that form them are not present in amounts that effect the novel and basic characteristics of the present invention.

By omitting these amines from the additive concentrate and ultimately the lubricant, the additive system will have a significantly reduced total base number (TBN) for the package. The additive concentrates covered by embodiments of this invention have a TBN<22, some cases less than 20, or less than 15, or less than 10, or even less than 5.

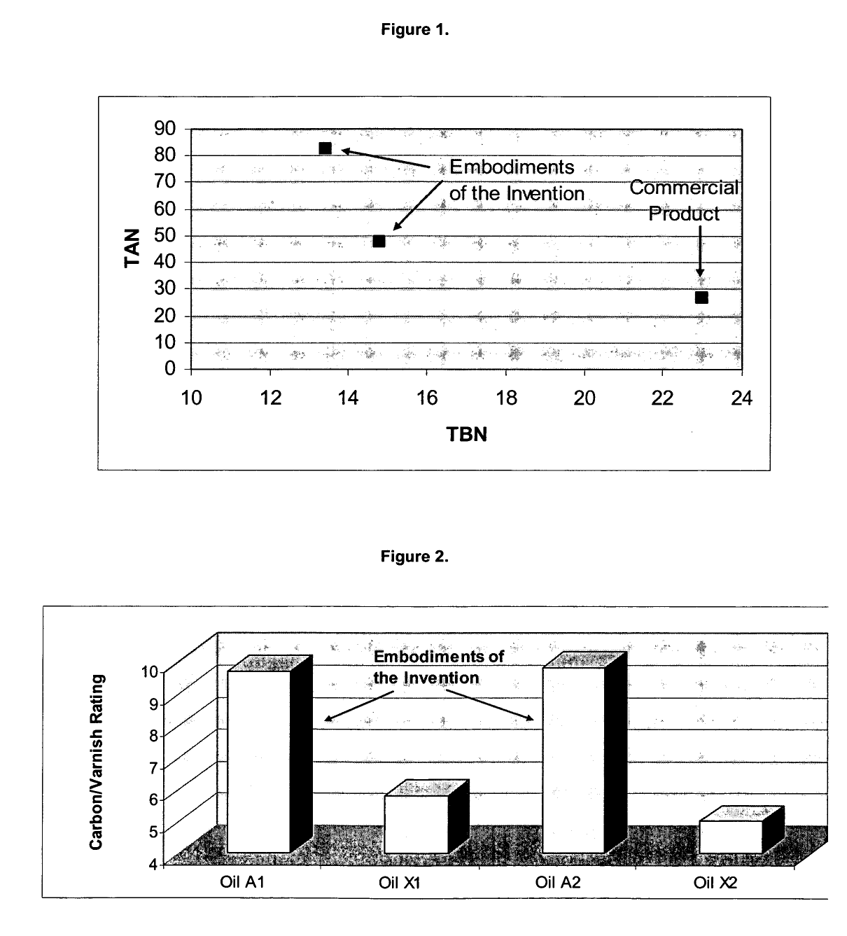

FIG. 1 is a plot of TBN and TAN (Total Acid Number) of a commercial additive package versus additive packages which are embodiments of the present invention. The commercial additive package was chosen because it has the lowest TBN in the population of commercial additive packages examined by the inventors. All other commercial packages tested by the inventors had higher TBN numbers. It is highly surprising that the additive packages according to embodiments of the present invention can provide the benefits set forth herein with low TBN in view of the TBN of tested commercial products.

In addition, by omitting essentially all of the low molecular (≦C30) hydrocarbyl amine rust inhibitors from the gear lubricant, and therefore eliminating the corresponding phosphate amine salts, a number of very important performance benefits may be achieved in embodiments, which in preferred embodiments contribute enhanced durability.

The first of these performance benefits is enhanced antiwear performance. As discussed in the experimental section below, testing according to the industry-recognized L-37 rig test (ASTM D6121) has shown significant improvements particularly in the low temperature version (conventionally known as the “Canadian version”) of this test.

Also, in embodiments, the oxidative stability of gear oils without the hydrocarbyl amine rust inhibitor described earlier is superior to those with such an amine present. It has been shown by embodiments that when these low molecular weight (<C30) hydrocarbyl amines are eliminated from a gear lubricant, the oxidation performance is dramatically improved. This can be demonstrated using the industry oxidation test called the L-60-1 (ASTM D5704).

Improved seal performance was also noted from a gear lubricant formulated in accordance with embodiments of the invention. The ASTM D5562 static seal test was run using both fluoroelastomer (Viton) and polyacrylate seal materials. In both tests, the elongation percent loss was significantly reduced.

Prior to the present invention, it was expected that fluids formulated without low molecular weight hydrocarbyl amine rust inhibitors would be deficient in the area of rust inhibition. In embodiments of the invention, the rust performance of gear lubricants prepared within the scope of the invention was evaluated using the automotive gear industry's L-33 test (ASTM D7038). The results demonstrate that fluids formulated in this manner had no steel corrosion deficiencies.

It is preferred that the additive package according to embodiments of the present invention also include at least one of the ingredients selected from the group consisting of: a sulfur-containing extreme pressure (EP) agent, a nitrogen-containing dispersant, and a corrosion inhibitor. Other preferred additives may include at least one ingredient selected from the group consisting of: borated dispersants, non-aminic rust inhibitors, defoamants, pour point depressants, antioxidants, demulsifiers, friction modifiers, seal swell agents, chromophores, deodorants, limited slip additives, detergents, and tackifiers.

In an embodiment, the invention is directed to an additive package comprising a minor amount of at least one substituted phosphoric acid composition characterized by the formula (R₁O)(R₂O)P(O)OH, where R₁ is a hydrocarbyl group and R₂ is either hydrogen or a hydrocarbyl group.

The lubricant composition preferably will also contain a sulfur-containing extreme pressure agent, as described more fully below.

The lubricant composition preferably also will contain nitrogen-containing dispersants and corrosion inhibitors, with the proviso that said species will be essentially free of low molecular weight primary, secondary, tertiary, cyclic aliphatic mono or polyamines with a carbon number of C30 or less.

In some instances, the additive package of embodiments of the invention will be mixed with, added to, dispersed in, or otherwise formulated to make a useful product with an oil of lubricating viscosity, such as a fluid categorized as being in one of the well-known API Group I-V. Lubricating fluids and greases in accordance with embodiments may comprise a major amount of such an oil of lubricating viscosity and the additive package as set forth herein. The term “major amount” means present in an amount greater than any other ingredient, based on wt. %. The “oil of lubricating viscosity” will also be described as a “base oil” herein, and may be a combination of one or more base oils, with the term “major amount” meaning the sum of the base oils are present in an amount greater than any other ingredient.

The additive package according to embodiments of the invention may comprise a small amount of an oil of lubricating viscosity to serve as a diluent and the like, present in a minor amount, such as 0-20 wt %, or about 0.5 to 15 wt %, or about 1 to 10 wt %, or about 2 to 8 wt %, or about 4 to 6 wt %, in the additive package. Contemplated ranges include any of the aforementioned lower limits to any of the aforementioned upper limits, e.g., about 0 to 6 wt %. The term “diluent” as used herein will imply a small amount, certainly less than a “major amount” for the sum total of diluent.

The products in accordance with embodiments of the present invention may be used, for instance, with an oil of lubricating viscosity, for a wide variety of automotive and industrial gear applications. Examples of such applications include use in hypoid axles and in mechanical steering drives in passenger cars and in cross-country vehicles. In addition, the product in accordance with embodiments of the present invention may be used in planetary hub reduction axles, mechanical steering and transfer gear boxes in utility vehicles such as trucks. It also can be used in different types of gear boxes, e.g. synchromesh gear boxes, as well as power take-off gears, limited slip axles, and Planetary hub reduction gear boxes. It may also be used in functional fluids, e.g., a circulating or process oil, in metal working, and the like.

It will be recognized that in certain instances it may be convenient to have a lubricant composition which is not completely formulated solely with the additive package according to embodiments of the invention, i.e., with a minor amount of additives left to be added by the final end consumer. However, for the purposes of the present specification, in the phrase “additive package suitable for preparing a fully formulated lubricant composition” the term “additive package” should be interpreted to mean the sum total of additives that are used to formulate the final lubricant or grease or other functional fluid.

Fluids that can meet the criteria of base oil for lubricant and functional fluids are varied. They may fall in any of the well-known American Petroleum Institute (API) categories of Group I through Group V. The API defines Group I stocks as solvent-refined mineral oils. Group I stocks contain the most unsaturates and sulfur and have the lowest viscosity indices. Group I defines the bottom tier of performance. Group II and III stocks are high viscosity index and very high viscosity index base stocks, respectively. The Group III oils contain the lowest level of unsaturates and sulfur relative to Group I and II oils. With regard to certain characteristics, both Group II and Group III oils perform better than Group I, particularly in the area of oxidative stability and low temperature performance.

Group IV stocks consist of polyalphaolefins, which can be produced via the catalytic oligomerization of linear alphaolefins (LAOs), with particularly preferable LAOs selected from C5-C14 linear alphaolefins, more preferably from 1-hexene to 1-tetradecene, more preferably from 1-octene to 1-dodecene, and mixtures thereof, although oligomers of lower olefins such as ethylene and propylene, oligomers of ethylene/butene-1 and isobutylene/butene-1, oligomers of ethylene with other higher olefins, such as described in U.S. Pat. No. 4,956,122, and the patents referred to therein, and the like, may also be used. PAOs typically offer superior volatility performance, thermal stability, and pour point characteristics to those base oils in Group I, II, and III.

Group V includes all the other base stocks not included in Groups I through IV. Group V base stocks include, e.g., esters, alkylated aromatics, polyintemal olefins (PIOs), polyisobutylenes, polyalkylene glycols (PAGs), etc.

The additive packages as disclosed herein may be formulated with any of the above five categories, API Groups I to V, as well as other materials.

In preferred embodiments, the additive package includes at least one ingredient selected from the group consisting of: one or more sulfur-containing extreme pressure agents, one or more acid phosphates (pentavalent phosphorus), one or more ashless dispersants, one or more corrosion inhibitors, and optionally anti-foamants, pour point depressants, friction modifiers, demulsifiers, tackifiers, VI improvers, deodorants, seal swell agents, and non-amine rust inhibitors, and mixtures thereof, with the proviso that said lubricating compositions are essentially free of or completely free of: (a) low molecular weight (≦C30) primary, secondary, tertiary, and cyclic hydrocarbyl amines; and (b) the corresponding acid phosphate amine salts.

While each of the aforementioned ingredients are per se known in the art, preferred ingredients are discussed in more detail below.

Extreme Pressure Agents

Extreme pressure (EP) agents used in the composition according to embodiments of the invention include known sulfur-containing and boron-containing EP agents. Sulfur-containing EP agents are preferred.

Sulfurized olefins are useful in providing protection against high pressure, metal to metal contacts in industrial and automotive gear oils. There is no particular restriction on the sulfur-containing extreme pressure additive that can be used in the additive package according to embodiments of the invention. Sulfur-containing components useful in this regard included sulfurized olefins, dialkyl polysulfides, diarylpolysulfides, sulfurized fats and oils, sulfurized fatty acid esters, trithiones, sulfurized oligomers of C2-C8 monoolefins, thiophosphoric acid compounds, sulfurized terpenes, thiocarbamate compounds, thiocarbonate compounds, sulfoxides, and thiol sulfinates. Mixtures of sulfur-containing EP components may be used.

The preferred sulfur-containing EP components are selected from sulfurized oligomers of C2-C8 monoolefins, olefins sulfides, and dialkyl and diaryl polysulfides. The more preferred extreme pressure agents are oligomeric olefin sulfides and dialkyl polysulfides. In the most preferred embodiment, the sulfurized olefin is prepared via a high pressure sulfurization procedure.

For some gear oil applications, it is possible that boron-containing EP additives may be adequate, provided that significant amounts of water are not present to cause hydrolysis. Use of boron-containing EP agents alone or with sulfur-containing EP agents is a contemplated aspect of embodiments of the invention. However, in preferred embodiments of the invention, the composition does not use an extreme pressure ingredient containing boron.

Dispersants

Dispersants serve inter alia to keep sludge and varnish particles from coating on the gear surfaces. There are no particular restrictions on the type used, though it is preferable that at least one contains nitrogen. Nitrogen-containing dispersants include alkyl succinimides, alkenyl succinimides, benzylamine compounds (Mannich bases) polybutenylamines, and the like. Borated versions of any of these are optional.

In preferred embodiments, nitrogen-containing dispersants are selected from alkyl succinimides and alkenyl succinimides. The preferred ashless dispersant for use in this invention are the products of reaction of a polyethylene polyamine, e.g. tetraethylene pentamine, with a hydrocarbon-substituted anhydride made by the reaction of a polyolefin, preferably having a molecular weight of about 700-5000 and especially 800-3000 (it is not particularly important whether this is number average molecular weight or weight average molecular weight) with an unsaturated polycarboxylic acid or anhydride, e.g. maleic anhydride.

Borated dispersants are optional and may be formed by borating ashless dispersants using suitable boron-containing compounds: boron acids, boron oxides, boron esters, and amine or ammonium salts of boron acids.

Corrosion Inhibitors/Metal Passivators

Corrosion inhibitors or metal passivators are typically additives that are heterocyclic in nature and are nitrogen-, and optionally, sulfur-containing. Triazole and its derivatives have been found to prevent corrosion in gear oils. Some specific examples include benzotriazole, tolyltriazole, 2-mercaptotriazole, dodecyltriazole. Alkyl and aryl derivatives are preferred.

A specific class of passivators is known as “copper passivators.” These comprise a class of compounds which includes thiadiazoles, triazoles, and thiazoles. The preferred compounds are the 1,3,4-thiadiazoles.

Phosphate Anti-wear Agents

In a preferred embodiment, the additive package includes an effective amount of at least one mono- and/or dialkyl acid phosphate for antiwear protection. An “effective amount” can be determined by one of ordinary skill in the art in possession of the present disclosure. Preferred mono- and/or dialkyl acid phosphates antiwear additives include at least one species represented by the formula (R₁O)(R₂O)P(O)OH, where R₁ is hydrocarbyl and R₂ is hydrocarbyl or hydrogen. R₁ and R₂ may have the same or different hydrocarbyl groups. Suitable hydrocarbyl groups are alkyl groups of 1-40 carbon atoms, preferably 2-20 and more preferably 3-20. The preferred acid phosphates for use in this invention are selected from mono- and di-2-ethylhexyl acid phosphates and mixtures thereof.

In prior art compositions, acid phosphates would be present as preformed salts using a low molecular weight hydrocarbyl amine or the salt would be formed in situ in the additive package and/or the fully formulated lubricant or grease (or at some other point between prior to or even during actual use). Such salts are described in, e.g., U.S. Pat. Nos. 2,063,629, 2,224,695, 2,447,288, 2,616,905, 3,728,260, 3,984,448, and 4,431,552. The hydrocarbyl amine is often termed a “rust inhibitor” and is usually a low molecular weight (<30 carbons) primary or secondary amine, but could also be tertiary or cyclic. The preferred amines are generally aliphatic in nature and possess from 4-30 carbon atoms. Some specific examples include the following: octylamine, decenylamine, dodecenylamine, oleylamine, and the like. In some cases, the art describes the most preferred amines as a complex with acid phosphates, where the aliphatic group of the amine is a tertiary alkyl group and the amine is a primary amine. Primene 81-R and Primene JMT amines are typically describes as most preferred.

The present inventors have surprisingly found that by eliminating essentially all of the low molecular weight hydrocarbyl amine “rust inhibitor”, and (without wishing to be bound by theory) the corresponding acid phosphate salt complex, the additive system will still possess adequate rust performance, even without the addition of other rust inhibitors and will also have, in at least some embodiments, at least one improved property selected from oxidation stability, seal compatibility and antiwear protection.

Other additives that may be included in the additive concentrate include: defoamants, non-aminic rust inhibitors, seal swell agents, friction modifiers, antioxidants, deodorants, chromophores, pour point depressants, tackifiers, demulsifiers, detergents, VI modifiers, and mixtures thereof. One of ordinary skill in the art, in possession of the present disclosure, can determine the nature and quantity of additives to provide in the fully formulated lubricant or grease without undue experimentation.

It should be noted that various ingredients may combine with the other ingredients to form salts, adducts, coordinated species, and the like. The combination of such species may be formed prior to addition to the final lubricant fluid, e.g., in the additive package of embodiments of the invention, such as in situ with a small amount of diluent (typically the final basestock) or they may be formed in situ after the ingredients are added to the basestock. Various combinations are possible. With this in mind, the present disclosure thus should be read in the nature of a recipe as regards the various additives described herein.

Furthermore, although all ingredients added to the final fully formulated lubricating fluid or greases described herein may be provided in a single additive package, the term “additive package” should be taken to mean any one additive package used or the entire sum of ingredients added to the one or more base oils used to create the final fully formulated composition.

### EXAMPLES

The following examples are meant to illustrate embodiments of the present invention and provide a comparison with lubricant formulations which, although heretofore considered adequate for commercial purposes, are not prepared in accordance with the present invention. While the examples of the invention are described with particularity, they should not be taken to limit the claims. Rather, numerous variations or modifications will become apparent to (and can be readily made by) those of ordinary skill in the art in light of these examples, particularly when viewed together with the entire disclosure.

For automotive applications, the oils were tested in the rig tests that are incorporated into API and SAE standards GL-5 and J2360, respectively. The L-37 test was used to assess antiwear performance; the L-60-1 was used for oxidative and thermal stability; and the static seal test ASTM D5662 was run for nitrile, polyacrylate and fluoroelastomer seal compatibility. The L-42 for protection against scoring and the L-33 and ASTM D130 for corrosion protection were also run to demonstrate no deficiencies as a result of amine elimination. For industrial gear oils, the ASTM D2783 Four Ball EP test and ASTM D665 for rust were run.

Automotive Example

To evaluate a gear lubricant according to embodiments of the present invention, the axle test ASTM D6121 was employed. This particular test is more commonly known as the L-37 test and is used in the industry to evaluate the antiwear performance of an automotive gear lubricant. This test method measures a lubricant's ability to protect final drive axles from abrasive wear, adhesive wear, plastic deformation, and surface fatigue, when subjected to low-speed high-torque conditions. Lack of protection can lead to premature gear or bearing failure or both.

The test apparatus is a new, complete, hypoid truck axle assembly, Dana Model 60 with 5.86 to 1 ratio. The assembly is mounted on a test stand with the pinion and axle shafts' center lines horizontal. The gears are first run through a conditioning phase and then through a test phase. The test phase is 24 h+0.2 h and is run at 275° F. with a load of 1740 ft-lb on each wheel and 80 rpms/min. At the end of the test, the differential is disassembled and the ring gear and pinion are inspected and rated for each type of distress (e.g. spalling, pitting, ridging, wear, rippling, etc.). The rating value is reported.

This same test method is also used for the Canadian version of the test, known as the Low Temperature (LT) L-37. The LT L-37 axle test is required for 75 W gear oils. This procedure is identical to the regular temperature L-37, except that the temperature of the test is run approximately 55° F. lower during both the conditioning and gear test phase.

The oxidative and thermal stability were evaluated in ASTM D5704 or the L-60/L-60-1 test, which is the most common test procedure for evaluating these features of automotive gear oils. The test covers the oil-thickening and insoluble/deposit formation characteristics of the lubricant when subjected to high temperature oxidizing conditions. For the L-60 test, the candidate lubricant is heated to 325° F./163° C. for 50 hr in a small gear box with two lightly loaded spur gears. Air is bubbled through the oil at a rate of 1 L/hr. The viscosity of the oxidized oil is measured at the end of the test and compared to the initial value. The pentane and toluene insolubles are also measured. The L-60-1 test is run in the same manner; however, the carbon-varnish and sludge are measured along with the insolubles and viscosity increase.

For seal compatibility, ASTM D5662 was run. This is a laboratory test method which evaluates gear oils for compatibility with various elastomers: nitrile, polyacrylate, and fluoroelastomer. This method addresses failures that may be caused by excessive elastomer hardening, elongation loss, and volume swell and attempts to determine the likelihood that an oil might cause premature sealing system failures in the field. Specimens are cut from the elastomer being evaluated and are immersed in oil for 240 hr. Reference oils are run periodically. The test temperature is dependent on the type of seal material used: 100° C. for nitrile and 150° C. for fluoroelastomer and polyacrylate. At the end of 240 hr, the aged elastomer specimens are tested for changes in hardness, elongation, tensile strength and volume.

Lubricating compositions, Oils A1 and A2 were prepared in accordance with the invention, whereas Oils X1 and X2 were formulated for comparison. The contents of these fluids are shown in Table 1 below. The additive systems of all examples use identical components, differing only in percentages. The additive percentages of X1 and X2 were manipulated to provide the closest approach to the percent of S, P, and N additives in A1 and A2, respectively, which is believed to provide the most valid comparison. The key difference between A1 and X1, and between A2 and X2, is the omission of the hydrocarbyl primary amine rust inhibitor in examples according to embodiments of the present invention. The TBNs for the resulting additive concentrates were calculated using a potentiometric method ASTM D2896. Oils A1 and A2 have a TBN=14.8 and Oils X1 and X2 have a TBN=27.9.

TABLE 1

| | Embodiment of | Comparison | Embodiment of | Comparison |
|---|---|---|---|---|
| | the Invention | Example | the Invention | Example |
| | Oil Code | | | |
| Test | A1 | X1 | A2 | X2 |

Additives in Finished Fluid, wt %

| | | | | | |
|---|---|---|---|---|---|
| EP Agent, Mobilad C-175 | | 3.65 | 4.24 | 3.65 | 4.24 |
| Antiwear - Mobilad C-421 - Acid Phosphate | | 1.13 | 1.37 | 1.13 | 1.37 |
| Amine Rust Inhibitor - Primary Amine (<C30) | | 0 | 0.59 | 0 | 0.59 |
| Dispersant, Borated and non-borated | | 3.51 | 2.00 | 3.51 | 2.00 |
| Copper Passivator - thiadiazole | | 0.54 | 0.25 | 0.54 | 0.25 |
| Other additives (inhibitors, antioxidants, defoamants) | | 1.19 | 1.19 | 1.19 | 1.19 |
| TBN of Additive System | ASTM D2896 | 14.8 | 27.9 | 14.8 | 27.9 |
| S in Finished Oil | | 2.07 | 2.19 | 1.95 | 2.190 |
| P in Finished Oil | | 0.128 | 0.157 | 0.125 | 0.158 |
| N in Finished Oil | | 0.14 | 0.14 | 0.14 | 0.11 |

Basestocks, wt %

| | | | | |
|---|---|---|---|---|
| PAO 2, 6 cSt | 20.0 | 20.4 | 26.0 | 26.4 |
| PAO 150 | 55.0 | 55.0 | 44.0 | 44.0 |
| Isononyl Heptanoate | 15.0 | 15.0 | 20.0 | 20.0 |

Viscometrics of Finished Fluid

| | | | | | |
|---|---|---|---|---|---|
| KV 100° C., cSt | ASTM D445 | 19.65 | 18.04 | 11.8 | 11.3 |
| VI | ASTM D2270 | 216 | 219 | 226 | 229 |
| Brookfield at −40° C., cP | ASTM D2983 | 21,495 | 17,300 | 7,318 | 6,470 |

In the L-60-1 test, Oils A1 and A2 had much improved carbon varnish ratings compared with Oil X1 and Oil X2. The results are shown in Table 2. Based on this test alone, the rating results for Oils X1 and X2 are considered as “failing”. FIG. 2 shows graphically the superior C-V performance of the candidate oils. Since the cleanliness is related to the C-V rating, it can be clearly stated that the oils A1 and A2 are cleaner. Also, pentane and toluene insolubles were non-existent for Oils A1 and A2 but around 0.3-0.4 mass percent for the oils X1 and X2. The sludge rating for all four oils was not significantly different.

An improvement in the seal compatibility was also observed for Oils A1 and A2 relative to Oil X2 in the seal test ASTM D5662 (testing of X1 was considered superfluous on the basis of the results for X2). The change in percent elongation was reduced for both the fluoroelastomer and polyacrylate with Oils A1 and A2 (see Table 2 for data), which implies that the candidate oils are having less affect on the elastomer than the comparative Oil X2.

The oils were evaluated in the ASTM D130 Copper Corrosion Test as well as in the L-33 Rust Test. The copper strip was rated 1b for all four oils. It is somewhat surprising that formulations without the prior art aminic rust inhibitor achieves the same result as the commercially acceptable formulations with the rust inhibitor. In the L-33 test, all formulations were well above the pass/fail line of 9.0 as referenced in SAE J2360 (see Table 2 for data).

The L-42 test is used for determining the anti-scoring properties of gear lubricants under high speed and shock conditions. It is described as having the same effect on gears as the start of a drag race. The test unit consists of Dana rear axle 44-1 with a gear ratio of 45:11. In a similar fashion as the L-37 test, the gears are mounted on a test stand with the pinion and axle shafts' center lines horizontal. The gears are put through a series of accelerations and decelerations against dynamometers under specified conditions of speed and torque for four cycles. The gear teeth are inspected at the end of the test for the amount of scoring on the tooth surface. The amount of scoring must be less than or equal to the pass reference oil. Both oils were tested and the data are presented in Table 2. Oils A1 and A2 had acceptable performance, proving the absence of the low molecular weight hydrocarbyl amine does not hurt scoring performance.

These data reveal that the automotive gear oils A1 and A2 had excellent performance, despite missing the rust inhibitor. Performance was better in areas of oxidation, anti-wear and seal performance and in areas that one might expect to be problematic, e.g. rust and copper corrosion, was not affected significantly.

TABLE 2

| | | Embodiment of | | Comparison | | Embodiment of | | Comparison | |
|---|---|---|---|---|---|---|---|---|---|
| | | the Invention | | Example | | the Invention | | Example | |
| | | Oil Code | | | | | | | |
| | Test | A1 | | X1 | | A2 | | X2 | |
| Copper Corrosion | ASTM D130 | 1b | | 1b | | 1b | | 1b | |
| L-37 Test, Uncoated Gears | ASTM D6121 | Pinion | Ring | Pinion | Ring | Pinion | Ring | Pinion | Ring |
| Burnish | | 5 | 5 | 5 | 5 | 5 | 5 | 5 | 5 |
| Discoloration | | 6 | 6 | 6 | 6 | 6 | 7 | 6 | 7 |
| Corrosion | | 10 | 10 | 10 | 10 | 10 | 10 | 10 | 10 |
| Deposits | | 10 | 9 | 10 | 10 | 10 | 10 | 9 | 9 |
| Wear | | 6 | 8 | 6 | 7 | 7 | 7 | 6 | 7 |
| Scoring | | 10 | 10 | 10 | 10 | 10 | 10 | 10 | 10 |
| Rippling | | 8 | 9 | 8 | 9 | 9 | 9 | 8 | 9 |
| Ridging | | 8 | 9 | 8 | 9 | 9 | 10 | 8 | 9 |
| Spitting | | 9.9 | 9.9 | 9.9 | 9.9 | 9.9 | 9.9 | 9.9 | 9.9 |
| Overall Merit | | 8.94 | | 8.92 | | 9.41 | | 8.92 | |
| Evaluation | | Pass | | Pass | | Pass | | Pass | |
| L-37 Test, Uncoated Gears, Low Temp. | ASTM D6121 | Pinion | Ring | Pinion | Ring | Pinion | Ring | Pinion | Ring |
| Burnish | | 5 | 5 | 5 | 5 | 5 | 5 | 3 | 5 |
| Discoloration | | 6 | 6 | 6 | 6 | 6 | 7 | 6 | 6 |
| Corrosion | | 10 | 10 | 10 | 10 | 10 | 10 | 10 | 10 |
| Deposits | | 10 | 9 | 10 | 7 | 10 | 9 | 10 | 8 |
| Wear | | 6 | 8 | 5 | 6 | 6 | 8 | 5 | 6 |
| Scoring | | 10 | 10 | 10 | 10 | 10 | 10 | 10 | 10 |
| Rippling | | 9 | 10 | 7 | 9 | 9 | 9 | 6 | 9 |
| Ridging | | 9 | 10 | 6 | 6 | 9 | 10 | 6 | 6 |
| Spitting | | 9.9 | 9.9 | 8.0 | 9.9 | 9.9 | 9.9 | 9.0 | 9.9 |

| | | | | | |
|---|---|---|---|---|---|
| Overall Merit | | 9.56 | 7.66 | 9.41 | 7.66 |
| Evaluation | | Pass | Fail | Pass | Fail |
| L-60-1 Test (n = 1) | ASTM D5704 | | | | |
| % Viscosity Increase | | 35 | 22 | 27 | 18 |
| Pentane Insolubles | | 0 | 0.40 | 0 | 0.35 |
| Toluene Insolubles | | 0 | 0.41 | 0 | 0.37 |
| Carbon/Varnish | | 9.7 | 5.8 | 9.8 | 5.0 |
| Sludge | | 9.5 | 9.62 | 9.7 | 9.49 |
| Evaluation | | Pass | Fail | Pass | Fail |

L-42

| % Scoring Ring, Coast | | 4 | 3 | 4 | 5 |
|---|---|---|---|---|---|
| % Scoring Pinion, Coast | | 6 | 5 | 9 | 8 |
| % of Pass/Fail Reference | | 26 | 24 | 33 | 32 |
| Evaluation | | Pass | Pass | Pass | Pass |
| Seal Compatibility | ASTM D5662 | | | | |
| Fluoroelastomer, % elongation change | | −14.7 | nd | −12.7 | −34.9 |
| Polyacrylate, % elongation change | | 11.0 | nd | 28.0 | 70.5 |
| Nltrile, % elongation change | | −55.8 | nd | −53.4 | −56.6 |
| L-33-1 Test | ASTM D7038 | | | | |
| Merit Rating | | 9.31 | 9.91 | 9.56 | 9.83 |
| Evaluation | | Pass | Pass | Pass | Pass |

Industrial Gear Fluids

Industrial gear fluids were also formulated in accordance with embodiments of the present invention and one was tested in an effort to demonstrate acceptable performance despite the omitted low molecular weight (≦C30) hydrocarbyl amine and the corresponding phosphate amine salt. Oil B was one such candidate, i.e. no low molecular weight (≦C30) hydrocarbyl amine was part of the additive system. Here again, the additive package's TBN was unusually low, measured at 4.5. Table 3 below shows the composition of the additive system and the mineral base oils that were employed.

TABLE 3

| | Embodiment | |
|---|---|---|
| | of the | Comparison |
| | Invention | Example |
| | Oil Code | |
| Test | B | Y |

Additives in Finished Lubricant, wt %

| | | | |
|---|---|---|---|
| EP Agent, Mobilad C-170 | | 0.56 | 0.56 |
| Antiwear - Mobilad | | 0.37 | 0.37 |
| C-421 - Acid Phosphate | | | |
| Amine Rust Inhibitor - | | 0 | 0.12 |
| Primary Amine (<C30) | | | |
| Dispersant, Borated | | 0.09 | 0.09 |
| and non-borated | | | |
| Copper passivator - | | 0.20 | 0.09 |
| thiadiazole | | | |
| Other additives | | 0.046 | 0.046 |
| (inhibitors, defoamants, | | | |
| demulsifiers) | | | |
| TBN of Additive System | ASTM D2896 | 4.5 | 27.8 |
| S in Finished Oil | | 0.275 | 0.275 |
| (additive contribution | | | |
| only) | | | |
| P in Finished Oil | | 0.0440 | 0.044 |
| N in Finished Oil | | 0.017 | 0.015 |

Basestocks, wt %

| | | |
|---|---|---|
| 150″ Solvent | 12.5 | 12.5 |
| Paraffinic Neutral | | |
| 150 Bright Stock | 86.0 | 86.0 |

Viscometrics

| | | | |
|---|---|---|---|
| KV, 100° C. | ASTM D445 | 23.6 | 23.7 |
| KV, 40° C. | ASTM D445 | 306.3 | 309.3 |
| VI | ASTM D2270 | 97 | 97 |

To evaluate the performance of the industrial gear lubricant disclosed herein, laboratory bench tests that are part of AIST 224 (formerly USS 224), AGMA 9005-E02, and other common industry specifications, were employed. Again, antiwear performance and rust protection were evaluated. ASTM D2783, a Four Ball EP Load Wear Test, measures the antiwear capability of the gear lubricant. One steel ball under load is rotated against three stationary balls immersed in oil. The load is increased until the weld point in kilograms is determined. The load wear index, an index of the ability of the lubricant to minimize wear at applied loads, is also measure. ASTM D4172 uses the Four Ball Test Machine to assess the wear preventive characteristics of lubricating fluids. A steel ball is rotated atop of three clamped balls at a rate of 1800 rpms for 60 min under a force of 20 kg at 75° C. The average wear scar of the three clamped balls is then determined. ASTM D665 is used to measure protection from steel corrosion. A mixture of test oil is mixed with either distilled water (Part A) or synthetic sea water (Part B) at a temperature of 60° C. with a cylindrical steel rod completely immersed. After four hours, the test rod is examined for signs of rusting. Copper corrosion performance was roughly equivalent for the two oils as determined by ASTM D130. The results for Oil B and comparison Oil Y are shown in Table 4.

TABLE 4

| | | Embodiment of | Comparison |
|---|---|---|---|
| | | the Invention | Example |
| | | Oil Code | |
| | Test | B | Y |
| Copper Corrosion | ASTM D130 | 1a | 1b |
| Four Ball Wear | ASTM D4172 | | |
| Wear Scar, mm | | 0.31 | 0.35 |
| Four Ball Weld | ASTM D2783 | | |
| Load Wear Index, kg | | 53 | 63 |
| Weld Point, kg | | 250 | 250 |
| Rust Test | ASTM D665 | | |
| Part A | | Pass | Pass |
| Part B | | Pass | Pass |

From these results, one can see there is no significant detrimental effect for this industrial gear oil when the hydrocarbyl amine rust inhibitors are omitted from the package. The rust test ASTM D665 is readily passed with both distilled and salt water. Copper corrosion protection is also satisfactory for the candidate fluid based on ASTM D130 results. The antiwear performance is roughly equivalent as evidenced by the Four Ball Wear and EP test results.

The invention has been described above with reference to numerous embodiments and specific examples. Many variations will suggest themselves to those skilled in this art in light of the above detailed description. All such obvious variations are within the full intended scope of the appended claims. Nevertheless, a few particularly preferred embodiments may be pointed out. One particularly preferred embodiment includes an additive package suitable for preparing a fully formulated lubricating fluid or grease including an effective amount of an acid phosphate-containing antiwear additive, the improvement comprising the absence of primary, secondary, tertiary, and cyclic aliphatic amines with a carbon number of C30 or less and the absence of the corresponding acid phosphate amine salts, with still more preferred embodiments, which may be combined as would be recognized by one of ordinary skill in the art in possession of the present disclosure, selected from: (i) wherein said additive package has a TBN<22 (or TBN<20, or TBN<15, or TBN<10, or TBN<5); (ii) wherein said acid phosphate is selected from at least one mono and/or dihydrocarbyl ester of an acid phosphate characterized by the formula (1):
(R₁O)(R₂O)P(O)OH (1)
where R₁ is a hydrocarbyl group and R₂ is selected from hydrogen or a hydrocarbyl group, which may be still more preferably characterized by the case where the hydrocarbyl groups of R₁ and R₂ are independently selected from straight-chained or branched alkyl groups having from 1 to 20 carbon atoms, or from 2 to 20 carbon atoms, or from 3 to 20 carbon atoms, and yet still more preferably wherein at least one of the hydrocarbyl groups R₁ and R₂ are 2-ethylhexyl acid phosphate; (iii) characterized as comprising at least one of the following ingredients: (a) at least one sulfur-containing extreme pressure agent; (b) at least one nitrogen-containing dispersant; (c) at least one corrosion inhibitor; (iv) further comprising at least one ingredient selected from the group consisting of borated dispersants, non-aminic rust inhibitors, defoamants, pour point depressants, antioxidants, demulsifiers, friction modifiers, seal swell agents, chromophores, deodorants, limited slip additives, detergents, VI modifiers, and tackifiers. Another particularly preferred embodiment includes an additive package suitable for use in driveline fluids and/or gear boxes for industrial applications characterized as essentially free of primary, secondary, tertiary and cyclic hydrocarbyl amines with a carbon number of C30 or less and essentially free of the corresponding acid phosphate amine salts, more preferably yet wherein said additive package further comprising an acid phosphate selected from at least one mono and/or dihydrocarbyl ester of an acid phosphate characterized by the formula (1):
(R₁O)(R₂O)P(O)OH (1)
where R₁ is a hydrocarbyl group and R₂ is selected from hydrogen or a hydrocarbyl group, and still more preferably at least one of the cases wherein: (i) at least one of the hydrocarbyl groups R₁ and R₂ are 2-ethylhexyl; (ii) wherein the composition is further characterized as comprising at least one of the following ingredients: (a) at least one sulfur-containing extreme pressure agent; (b) at least one nitrogen-containing dispersant; (c) at least one corrosion inhibitor.

Unless specified otherwise herein, the meanings of terms used herein shall take their ordinary meaning in the art; reference shall be taken, in particular, to Synthetic Lubricants and High-Performance Functional Fluids, Second Edition, Edited by Leslie R. Rudnick and Ronald L. Shubkin, Marcel Dekker (1999). This reference, as well as all patents and patent applications, test procedures (such as ASTM methods and the like), and other documents cited herein are fully incorporated by reference to the extent such disclosure is not inconsistent with this invention and for all jurisdictions in which such incorporation is permitted. Note that Trade Names used herein are indicated by a ™ symbol or ® symbol, indicating that the names may be protected by certain trademark rights, e.g., they may be registered trademarks in various jurisdictions. Note also that when numerical lower limits and numerical upper limits are listed herein, ranges from any lower limit to any upper limit are contemplated.

What is claimed is:

1. In an additive package suitable for preparing a fully formulated lubricating fluid or grease including an effective amount of an acid phosphate-containing antiwear additive, the improvement comprising the absence of primary, secondary, tertiary, and cyclic aliphatic amines with a carbon number of C30 or less and the absence of the corresponding acid phosphate amine salts.

2. The additive package of claim 1, wherein said additive package has a TBN<22.

3. The additive package of claim 1, wherein said additive package has a TBN<20.

4. The additive package of claim 1, wherein said additive package has a TBN<15.

5. The additive package of claim 1, wherein said additive package has a TBN<10.

6. The additive package of claim 1, wherein said additive package has a TBN<5.

7. The additive package of claim 1, wherein said acid phosphate is selected from at least one mono and/or dihydrocarbyl ester of an acid phosphate characterized by the formula (1):
(R₁O)(R₂O)P(O)OH (1)
where R₁ is a hydrocarbyl group and R₂ is selected from hydrogen or a hydrocarbyl group.

8. The additive package of claim 7, wherein the hydrocarbyl groups of R₁ and R₂ are independently selected from straight-chained or branched alkyl groups having from 1 to 20 carbon atoms.

9. The additive package of claim 7, wherein the hydrocarbyl groups of R₁ and R₂ are independently selected from straight-chained or branched alkyl groups having from 2 to 20 carbon atoms.

10. The additive package of claim 7, wherein the hydrocarbyl groups of R₁ and R₂ are independently selected from straight-chained or branched alkyl groups having from 3 to 20 carbon atoms.

11. The additive package of claim 7, wherein at least one of R₁ and R₂ is 2-ethylhexyl.

12. The additive package of claim 1, further characterized as comprising at least one of the following ingredients:
(a) at least one sulfur-containing extreme pressure agent;
(b) at least one nitrogen-containing dispersant;
(c) at least one corrosion inhibitor.

13. The additive package of claim 12, characterized as comprising at least two of the ingredients (a)-(c).

14. The additive package of claim 12, characterized as comprising ingredients (a)-(c).

15. The additive package of claim 12, further comprising at least one ingredient selected from the group consisting of borated dispersants, non-aminic rust inhibitors, defoamants, pour point depressants, antioxidants, demulsifiers, friction modifiers, seal swell agents, chromophores, deodorants, limited slip additives, detergents, VI modifiers, and tackifiers.

16. An additive package suitable for use in driveline fluids and/or gear boxes for industrial applications characterized as essentially free of primary, secondary, tertiary and cyclic hydrocarbyl amines with a carbon number of C30 or less and essentially free of the corresponding acid phosphate amine salts.

17. The additive package of claim 16, further comprising an acid phosphate selected from at least one mono and/or dihydrocarbyl ester of an acid phosphate characterized by the formula (1):
(R₁O)(R₂O)P(O)OH (1)
where R₁ is a hydrocarbyl group and R₂ is selected from hydrogen or a hydrocarbyl group.

18. The additive package of claim 17, wherein at least one of R₁ and R₂ is 2-ethylhexyl.

19. The additive package of claim 17, further characterized as comprising at least one of the following ingredients:
(a) at least one sulfur-containing extreme pressure agent;
(b) at least one nitrogen-containing dispersant;
(c) at least one corrosion inhibitor.

20. The additive package of claim 17, further characterized as comprising the following ingredients:
(a) at least one sulfur-containing extreme pressure agent;
(b) at least one nitrogen-containing dispersant;
(c) at least one corrosion inhibitor.
